(19) United States
(12) Patent Application Publication
(10) Pub. No.: US 2008/0018074 A1
(43) Pub. Date: Jan. 24, 2008

(54) Two-Piece Vehicle Step Tube

(75) Inventors: Charles J. Steffens, Ada, MI (US); Scott A. Currie, Birmingham, MI (US); Christopher P. Hilton, Northville, MI (US)

Correspondence Address: WARNER NORCROSS & JUDD LLP, 900 FIFTH THIRD CENTER, 111 LYON STREET, N.W., GRAND RAPIDS, MI, 49503-2487, US

(73) Assignee: STEFFENS ENTERPRISES, INC., Caledonia, MI (US)

(21) Appl. No.: 11/458,139

(22) Filed: Jul. 18, 2006

(51) Int. Cl. B60R 3/00

(52) U.S. Cl. 280/163

(57) ABSTRACT

A vehicle step tube having a one-piece extruded body and a one-piece extruded step tread slidably interfitted together. The tube is fabricated of aluminum, and the step tread is fabricated of plastic or rubber. The step tread and the body are of substantially the same length so that the step tread provides a continues non-skid surface along the entire upper surface of the step tube.

### BACKGROUND OF THE INVENTION

The present invention relates to vehicle step tubes and more particularly to extruded vehicle step tubes.

Step tubes and running boards are commonly installed on vehicles to assist users of the vehicles in climbing into and out of the vehicles. The step tubes also are installed for aesthetic reasons and to protect the side of the vehicle.

A variety of step tubes are fabricated from one or more extruded aluminum components. Examples of such step tubes are illustrated in U.S. Pat. No. 6,588,782 issued Jul. 8, 2003 to Coomber; U.S. Publication No. 2005/0263974 dated Dec. 1, 2005 and filed by Mulder; and U.S. Publication No. 2005/0263975 published Dec. 1, 2005 and filed by Mulder et al.

The Coomber step tube requires considerable fabrication and assembly of multiple extruded components. Consequently, manufacture of the Coomber step tube requires significant manufacture, inventory, labor, and consequently expense.

The Mulder step tubes comprise significant advances in the step tube art. However, consumer demand continues for new products providing additional functionality and aesthetics.

### SUMMARY OF THE INVENTION

The aforementioned problems are overcome in the present invention in which a vehicle step tube includes two components—a step tube body and a step tread—that interlock with one another.

In a first embodiment, both the body and the step tread are extruded; and the two components slidably interlock with one another. As disclosed, the two components include track elements that enable the two components to be slid together longitudinally to hold the two components together. Currently, the step tube assembly includes means for longitudinally intersecuring the two components so that they do not slide relative one another following assembly.

In a second embodiment, the step tread is molded enabling the upper surface of step tread to be provided with a wide variety of designs and configuration.

The step tread of either embodiment can be fabricated of a non-skid material to provide a secure stepping surface. Optionally, the step tread can be transparent or translucent, enabling lights within the step tube to be seen through the tread. The step tread currently extends the full length of the tube body to provide a secure surface along the entire length of the step tube. Alternatively, the step tread(s) can be located at discrete locations along the length of the tube.

The step tubes of the present invention provide enhanced functionality and aesthetics. Additionally, the construction is relatively simple, resulting in reduced labor, reduced inventory, and consequently reduced cost.

These and other objects, advantages, and features of the invention will be more fully understood and appreciated by reference to the description of the current embodiment and the drawings.

### BRIEF DESCRIPTION OF THE DRAWINGS

FIG. 1 is an exploded perspective view of the step tube assembly and a vehicle body;

FIG. 2 is a perspective view of the step tube assembly;

FIG. 3 is a perspective view of the step tube, including the body and the step tread; and

FIG. 4 is an end view of the step tube.

### DESCRIPTION OF THE CURRENT EMBODIMENT

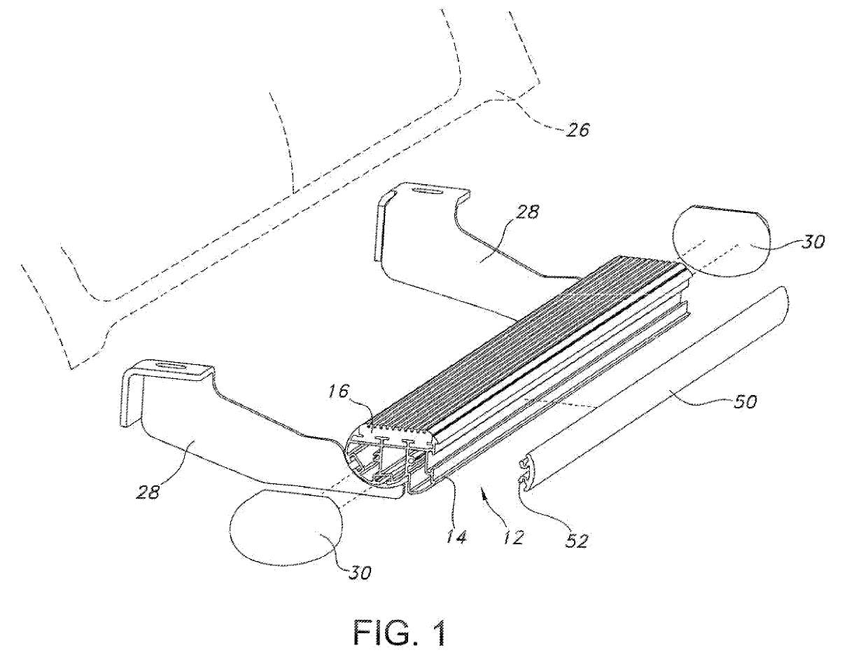

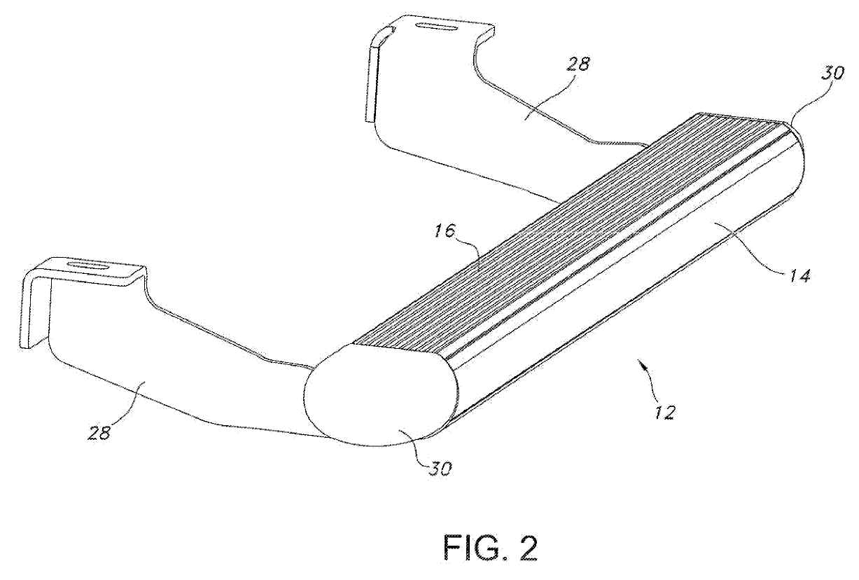

A step tube assembly constructed in accordance with a current embodiment of the invention is illustrated in FIGS. 1 and 2 and generally designated 10. The step tube assembly 10 includes a step tube 12, mounting brackets 28, ends caps 30, and a strip 50. The step tube 12 in turn includes a body 14 and a step tread 16. The mounting brackets 28 are used for attaching the step tube to a vehicle 26. The end caps 30 are mounted on the opposite ends of the step tube 12 to prevent the step tread 16 from sliding on the body 14 (following assembly) and to finish the ends of the tube. The strip 50 is supported by the tube body 14 for aesthetic and protective purposes.

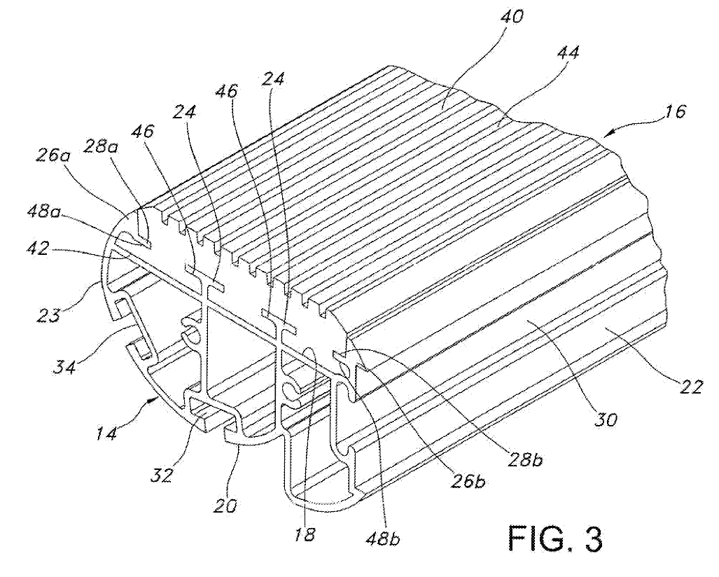

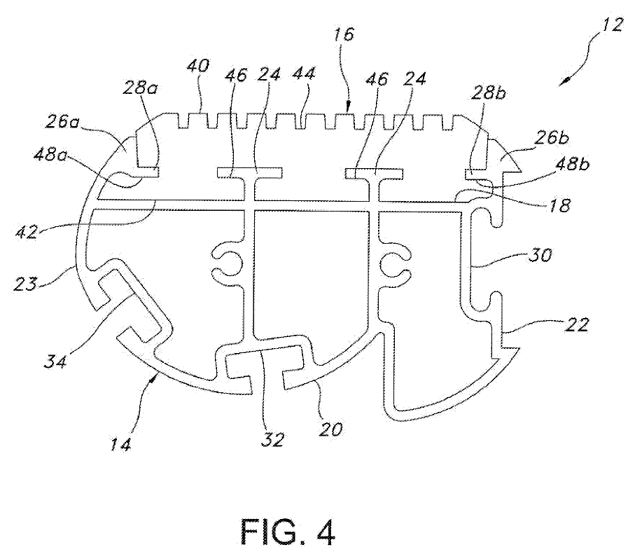

As illustrated in FIGS. 3 and 4, the step tube 12 includes a body 14 and a step tread 16. The body 12 is an elongated beam. In the current embodiment, the beam in an aluminum extrusion. Alternatively, the beam may be extruded from a another metal or alloy, a plastic, or any other suitable material. The beam includes an upper surface 18, a lower surface 20, and an outwardly facing surface 22 extending therebetween. A pair of T-shaped flanges 24 extend upwardly from the upper surface 18. A pair of side flanges 26a and 26b also extend upwardly from the lateral edges of the upper surface 18. The side flanges 26a and 26b include inwardly extending flanges 28a and 28b respectively.

The outwardly facing surface 22 defines a C-shaped channel 30 for receiving the strip 50. The bottom surface 21 and the inwardly facing surface 23 each define T-shaped channels or slots 32 and 34 respectively. The slots receive attachment brackets 28 (see FIG. 1) in conventional fashion to support the step tube 10 on the vehicle 26.

The step tread 16 also is currently an extruded component fabricated of plastic or rubber. Other non-skid materials and/or surface treatments known to those skilled in the art could also be used. The step tread includes an upper surface 40 and a lower surface 42. The upper surface may be grooved or otherwise surface treated to enhance its non-skid character. A pair of T-shaped slots 46 extend into the step tread 16 through the lower surface 42. The slots 46 are shaped and dimensioned to correspond to the T-shaped flanges 24. Similarly, channels 48a and 48b extend into the step tread 16 through its lateral sides. The channels 48a and 48b are dimensioned to correspond to the flanges 28a and 28b respectively.

The flanges 24 and 28 and the channels 46 and 48 comprise track elements along which the step tread and body travel as the two pieces are slid together. These track elements permit relative longitudinal movement between the body and the step tread, but prevent transverse movement between the two components.

Alternatively, the step tread 16 could be a molded of a wide variety of materials, but most likely plastic or rubber. If molded, the step tread could have a wide variety of shapes and sizes, including those of the extruded step. Molding also would enable a wide variety of designs to be molded into the upper surface of the step tread. It is possible that molded step treads might snap onto or into the body 14, rather than sliding as illustrated in the current embodiment. Other attachment means, such as screws and/or rivets, could be used.

Further alternatively, the step tread 16—either extruded or molded—could be fabricated of a transparent or translucent material. Consequently, the body 14 would be wholly or partially visible through the step tread 16. The possibility of including lights within the tube 12 also is contemplated, and a transparent or translucent step tread 16 would enable the lights to be wholly or partially visible through the step tread.

In the current embodiments, each of the body 14 and the step tread 16 extend the full length of the step tube 12. Alternatively, The step tread 16 may be fabricated in discrete segments positioned along the step tube or in some other configuration in which the step tread would not be continuous and/or would not extend the full length of the step tube body 14. If the step tread does not extend the full length of the step tube, spacers (not shows) or other devices might be installed on the step tube adjacent to and/or in between the step tread segment(s). Such spacers might have a different shape, color, or other appearance characteristic to visually direct the user to the step tread(s). If the step treads are lit, the spacers might be opaque and or a different color, again to direct the user to the step tread(s).

The strip 50 is of conventional design. In the current embodiment, the strip 50 is extruded of plastic or rubber. Virtually any other material also could be used. The strip 50 includes a somewhat bulbous flange 52 which is closely received within the C-shaped channel 30 to secure the strip 50 on the outwardly facing surface 22 of the body 14.

The colors of the body 14, the step tread 16, the end caps 30, and the protective strip 50 are selected to provide a desired appearance for the step tube 12. In one embodiment, the colors of these components are all the same to provide a unitary appearance. In other embodiments, the components could have different colors. For example, one color scheme might have subtly complementary colors, while another scheme might have highly contrasting eye-catching colors. The ability to provide different colors to the components enables a virtually limitless configuration of appearances.

### Assembly and Installation

Manufacture of the step tube assembly 10 involves the steps of a) extruding the body 14, the step tread 16, and the strip 50 in separate operations, b) longitudinally aligning the tread and the body, c) sliding those two pieces together, d) longitudinally aligning the installing the strip 50 and the body, e) sliding those two pieces together, f) and installing the end caps 30. In the alternative embodiments having multiple step treads and/or spacers, all of those pieces are installed before both end caps are installed. The end caps prevent relative longitudinal movement between the body and the step tread. The brackets are shipped with, but separated from, the remainder of the step tube assembly for subsequent use in installing the step tube assembly on a vehicle.

Alternatively, the step tread 16 may be molded rather than extruded. In such case, the step tread 16 may be either slid longitudinally onto the body 14 or snap fitted, screwed, riveted, or otherwise attached to the body.

The step tube provides a strong, simple, and safe construction. The aluminum body 14 provides the requisite strength, and the non-skid step tread 16 provides an appropriate stepping surface.

The above descriptions are those of current embodiments of the invention. Various alterations and changes can be made without departing from the spirit and broader aspects of the invention as defined in the claims, which are to be interpreted in accordance with the principles of patent law including the doctrine of equivalents.

The embodiments of the invention in which an exclusive property or privilege is claimed are defined as follows:

1. A vehicle step tube comprising:
an elongated body having an upper portion and a lower portion;
an elongated step tread on said upper portion of said body;
said body and said step including intersecuring means for transversely securing said step on said body, said intersecuring means permitting said step tread to move longitudinally with respect to said body, said intersecuring means restricting said step tread from moving transversely with respect to said body.

2. A vehicle step tube as defined in claim 1 further comprising means for securing said step tread in a fixed longitudinal position with respect to said body.

3. A vehicle step tube as defined in claim 1 wherein:
said body is fabricated of aluminum; and
said tread is fabricated of a non-skid material.

4. A vehicle step tube as defined in claim 1 wherein said intersecuring means comprises:
one of said body and said step tread defining a channel; and
the other of said body and said step tread including a flange slidably received within said channel.

5. A vehicle step tube as defined in claim 1:
wherein said body defines an outwardly facing surface; and
further comprising a strip supported on said outwardly facing surface.

6. A vehicle step tube as defined in claim 1 wherein the length of the step tread is substantially the same as the length of said body.

7. A vehicle step tube as defined in claim 1 wherein said step tread is at least one of transparent and translucent.

8. A vehicle step tube comprising:
a one-piece elongated body;
a one-piece elongated step tread;
said body and said step tread integrally including means for intersecuring said step tread and said body.

9. A vehicle step tube as defined in claim 8 wherein said intersecuring means:
permits said body and said step tread to be slidably interfitted; and
permits transverse movement between said body and said step tread.

10. A vehicle step tube as defined in claim 9 further comprising means for preventing relative longitudinal movement between said body and said step tread.

11. A vehicle step tube as defined in claim 8 wherein:
said body is fabricated of aluminum; and
said tread is fabricated of a non-skid material.

12. A vehicle step tube as defined in claim 8 wherein said intersecuring means comprises:
one of said body and said tread including a flange; and
the other of said body and said tread defining a channel slidably receiving said flange.

13. A vehicle step tube as defined in claim 8:
wherein said body includes an outwardly facing surface; and
further comprising a strip supported on said outwardly facing surface.

14. A vehicle step tube as defined in claim 8 wherein the length of the step tread is substantially the same as the length of said body.

15. A vehicle step tube as defined in claim 8 wherein said step tread is at least one of transparent and translucent.

16. A method of assembling a vehicle step tube comprising the steps of:
providing a body having a first longitudinal track element;
providing a step tread having a second longitudinal track element;
aligning the track elements;
sliding the step tread longitudinally onto the body with the track elements interfitting to prevent transverse separation of the step tread and the body; and
securing the step tread and the body in fixed longitudinal relationship to prevent relative movement therebetween.

17. A method as defined in claim 14 wherein:
the first track element is one of a flange and a channel; and
the second track element is the other of a flange and a channel, the flange being slidably received within the channel.

18. A method as defined in claim 14, wherein:
the body is aluminum; and
the step tread is a non-skid material.

19. A method as defined in claim 14 further comprising the step of mounting a strip on an outwardly facing surface of the body.

20. A method as defined in claim 14 wherein the step tread and the body are of substantially the same length.

21. A method as defined in claim 14 wherein the body and the step tread are extruded.

22. A method as defined in claim 14 wherein the step tread is at least one of transparent and translucent.

23. A vehicle step tube comprising:
a body having a body length; and
a step tread mounted on said body, said step tread having a step tread length substantially the same as the body length.

24. A vehicle step tube comprising:
a body; and
a step tread mounted on said body and fabricated of a non-skid material.

25. A vehicle step tube as defined in claim 24 wherein said non-skid material is at least one of plastic and rubber.

26. A vehicle step tube comprising:
a body; and
a step tread mounted on said body, said step tread being at least one of transparent and translucent.
